(19) United States
(12) Patent Application Publication
(10) Pub. No.: US 2005/0202298 A1
(43) Pub. Date: Sep. 15, 2005

(54) Fuel cell

(75) Inventors: Hiroshi Okazaki, Kariya-shi (JP); Katsuhiro Kajio, Anjo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: AISIN SEIKI KABUSHIKI KAISHA, Kariya-shi (JP); TOYOTA JIDOSHA KABUSHIKI KAISHA, Toyota-shi (JP)

(21) Appl. No.: 11/074,696

(22) Filed: Mar. 9, 2005

(30) Foreign Application Priority Data
Mar. 10, 2004 (JP) 2004-067113

(51) Int. Cl. H01M 8/10; H01M 8/00; H01M 2/08; H01M 2/00; H01M 2/02; H01M 2/14

(52) U.S. Cl. 429/32; 429/38; 429/39; 429/34; 429/35

(57) ABSTRACT

A fuel cell includes a cell stack formed by stacking a plurality of cells, each cell having a membrane electrode assembly having an electrolyte membrane and an electrode provided at each side of the electrolyte membrane, a flow channel for supplying fluid to the electrode, and separators each having a flow path from the flow channel to outside the fuel cell stack, a pair of terminals provided so as one terminal is positioned at one end of the cell stack and the other terminal is positioned at the other end of the cell stack, a pair of pressure plates provided for sandwiching and fastening the cell stack from outside the terminals, each pressure plate including an inlet/outlet hole connected to the flow path, and a pipe member connected to the flow path, the pipe member being made of a corrosion resistant material, and including a pipe portion inserted into the inlet/outlet hole, and a flange portion at the cell stack side of one of the pressure plates. One of the terminals has an accommodating portion for accommodating the pipe member, and a gap is formed between the flange portion of the pipe member and the cell stack under a zero contacting condition when a pressure load of the pair of the pressure plates is zero, in which any one of the members of the cell stack and the terminal provided between the pressure plates is in contact with the neighboring member.

### CROSS REFERENCE TO RELATED APPLICATIONS

This application is based on and claims priority under 35 U.S.C. § 119 to Japanese Patent Application 2004-067113, filed on Mar. 10, 2004, the entire content of which is incorporated herein by reference.

### FIELD OF THE INVENTION

The present invention generally relates to a fuel cell. More particularly, the present invention relates to a fuel cell having a corrosion resistant material for preventing an increase in contact resistance in a case where an inlet/outlet hole is covered with a corrosion resistant member.

### BACKGROUND

A polymer electrolyte fuel cell system generally includes a cell stack having plural cells, in which a membrane electrode assembly having a polymer electrolyte membrane sandwiched by two electrodes (a fuel side electrode and an air side electrode sandwiched by separators) is included, terminals, insulators, and pressure plates provided at both side ends of the cell stack in a stacking direction; a fuel gas supplying means for supplying fuel gas to the fuel cell electrode side, an oxidant gas supplying means for supplying oxidant gas to the air side electrode; several kinds of gas pipe; and a controller for controlling the polymer electrolyte fuel cell system. The each of the pressure plates includes an inlet/outlet hole for gas. The each of the separators includes a gas flow channel for supplying at least one of fuel gas and air gas to the electrode, and a gas flow path (a manifold) for connecting from the gas flow channel to the inlet/outlet hole of the each of the pressure plates. One of the pressure plates is provided at one side end of the cell stack in stacking direction. The other of the pressure plates is provided at the other side end of the cell stack. Both of the pressure plates are fastened with use of a fastening member in order to prevent leakage of fuel gas or air gas.

In the electrolyte polymer fuel cell, reaction, in which hydrogen is separated into hydrogen ions and electrons, is implemented at the fuel side electrode. The hydrogen ions are transferred to the air side electrode through the electrolyte membrane. On the other hand, a reaction, in which water is generated from oxygen, hydrogen ions and electrons (the electrons generated at the anode of the MEA and transferred from the anode), is carried out at the air side electrode.

Fuel side electrode (anode): H₂→2H⁺+2e⁻

Air side electrode (cathode):

$$2 {H}^{+} + 2 {e}^{-} + \frac{1}{2} {O}_{2} \to {H}_{2} O$$

In a case where an electrolyte is an electrolyte polymer membrane, there is a need to add moisture, of a greater amount than that required amount for the reaction described above, to the fuel gas supplied. There is also a need to add moisture to the air gas supplied. The moisture added tends to cause corrosion of the pressure plate (made of metal) or terminal. The corroded substance generated at the inlet/outlet hole tends to be gradually broken away, and interferes with the gas flow path of the separator. Then, a lack of supply in gas occurs, and performance of the fuel cell is degraded. Further, if corrosion occurs at the gas flow channel of the separator, a corrosive, or ions generated by dissipated metal, tend to contaminate the catalyst of the electrode or the electrolyte, and the performance of the fuel cell is also degraded.

In terms of the cooling water path, the inlet/outlet hole of the pressure plate (made of metal), or that of the terminal, is corroded by cooling water. The corroded substance generated at the inlet/outlet hole tends to be broken away gradually, and interferes with the cooling water path. Then, temperature control of the fuel cell becomes difficult, and performance of the fuel cell is degraded. Further, metal ions generated from the metal part of the inlet/outlet hole tends to get mixed into the cooling water. Then, electric conductivity of the cooling water tends to be raised, the raised electric conductivity of the cooling water causes a leakage of an electric current, and performance of the fuel cell is degraded.

According to JP2000-164238A, a fuel cell intended to overcome the problems described above is described. The fuel cell includes a pressure plate for sandwiching and fastening a cell stack having plural cells 1 having a membrane electrode assembly sandwiched by separators having a gas flowing channel for supplying at least one of fuel gas and oxidant gas to an electrode. The pressure plate includes an inlet/outlet hole for supplying or ejecting the fuel gas, oxidant gas, or cooling water. At least one of the inlet/outlet hole has corrosion resistance (the inlet/outlet hole is covered with a corrosion-resistant member such as resin, or ceramics). According to the fuel cell described above, generation of corroded substances and metal ions, which cause contamination of the catalyst of the electrode or the electrolyte, can be inhibited.

However, in case where the inlet/outlet hole is covered with the corrosion-resistant member such as resin or ceramics, difference in a height will be generated between a terminal in contact with a front surface of the separator of a cell of the fuel cell and a sealing surface of the inlet/outlet hole of the pressure plate. The difference in height makes an area in which electric current is transmitted narrower than an apparent contacting area. Then, contact resistance tends to increase, and performance of the fuel cell tends to be degraded. Further, a deformation margin of a sealing between the inlet/outlet hole of the separator and that of the pressure plate becomes short, and fluid (fuel gas, air gas, moisture) tends to leak out. Further, load on the contacting surface tends to be uneven, and the cell, or the like, tends to be broken.

A need thus exists for a fuel cell, in which an increase in contact resistance can be prevented even in a case where an inlet/outlet hole is covered with a corrosion-resistant member.

A need also exists for a fuel cell, in which leakage of fluid can be prevented, even in a case where an inlet/outlet hole is covered with a corrosion resistant member.

A need also exists for a fuel cell, in which breakage of a cell, or the like, can be prevented, even in a case where an inlet/outlet is covered with a corrosion resistant member.

### SUMMARY OF THE INVENTION

According to an aspect of the present invention, a fuel cell includes a cell stack formed by stacking a plurality of cells, each cell having a membrane electrode assembly having an electrolyte membrane and an electrode provided at each side of the electrolyte membrane, a flow channel for supplying fluid to the electrode, and separators each having a flow path from the flow channel to outside the fuel cell stack, a pair of terminals provided so as one terminal is positioned at one end of the cell stack and the other terminal is positioned at the other end of the cell stack, a pair of pressure plates provided for sandwiching and fastening the cell stack from outside the terminals, each pressure plate including an inlet/outlet hole connected to the flow path, and a pipe member connected to the flow path, the pipe member being made of a corrosion resistant material, and including a pipe portion inserted into the inlet/outlet hole, and a flange portion at the cell stack side of one of the pressure plates. One of the terminals has an accommodating portion for accommodating the pipe member, and a gap is formed between the flange portion of the pipe member and the cell stack under a zero contacting condition when a pressure load of the pair of the pressure plates is zero, in which any one of the members of the cell stack and the terminal provided between the pressure plates is in contact with the neighboring member.

According to a further aspect of the present invention, a fuel cell includes a cell stack formed by stacking a plurality of cells, each stacked cell having a membrane electrode assembly having an electrolyte membrane and an electrode provided at each side of the electrolyte membrane, a flow channel for supplying fluid to the electrode, and separators each having a flow path from the flow channel to outside the cell stack. When a pressure load applied to the cell stack in a stacking direction is zero, and when cells adjacent each other is in contact with each other at a time of a zero contacting condition, a gap is provided between flange portions of the separators of the adjacent cells.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a cross-sectional view of a schematic structure of a fuel cell in a stacking direction according to the embodiment of the present invention;

FIG. 2 represents a partial cross-sectional view of a detailed schematic structure of a cell stack of the fuel cell according to the first embodiment of the present invention;

FIG. 3 represents a cross-sectional view of a schematic structure of an area surrounding the inlet/outlet of the fuel cell according to the first embodiment of the present invention;

FIG. 4 represents a cross-sectional view of a schematic structure of the fuel cell in a zero contacting condition when a pressure load is zero according to the first embodiment of the present invention;

FIG. 5A represents a plane view indicating a position of an inlet/outlet hole provided at a first end plate (a first pressure plate) of the fuel cell according to the first embodiment of the present invention;

FIG. 5B also represents a plane view indicating a position of an inlet/outlet hole provided at a first end plate (a first pressure plate) of the fuel cell according to the first embodiment of the present invention;

FIG. 6 represents a cross-sectional view of a schematic structure of the fuel cell in a zero contacting condition, when a pressure load is zero, according to a second embodiment of the present invention.

FIG. 7 represents a cross-sectional view of a schematic structure of the fuel cell in a zero contacting condition, when a pressure load is zero, according to a third embodiment of the present invention.

FIG. 8 represents a cross-sectional view of a schematic structure of the fuel cell in a zero contacting condition, when a pressure load is zero, according to a fourth embodiment of the present invention.

FIG. 9 represents a cross-sectional view of a schematic structure of the fuel cell in a zero contacting condition, when a pressure load is zero, according to a fifth embodiment of the present invention.

### DETAILED DESCRIPTION

Embodiments of the present invention will be described hereinbelow in detail with reference to the accompanying drawings.

### First Embodiment

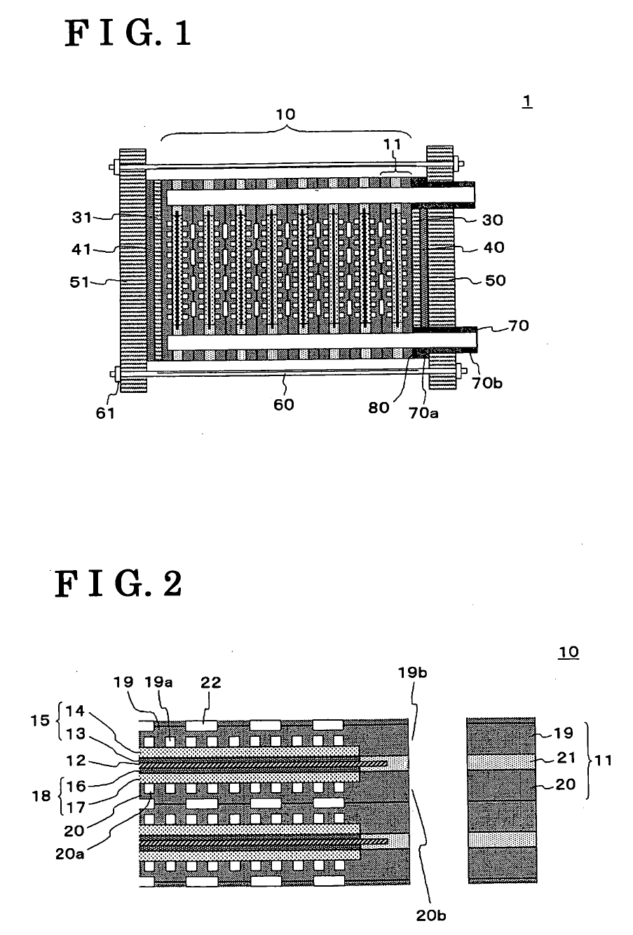

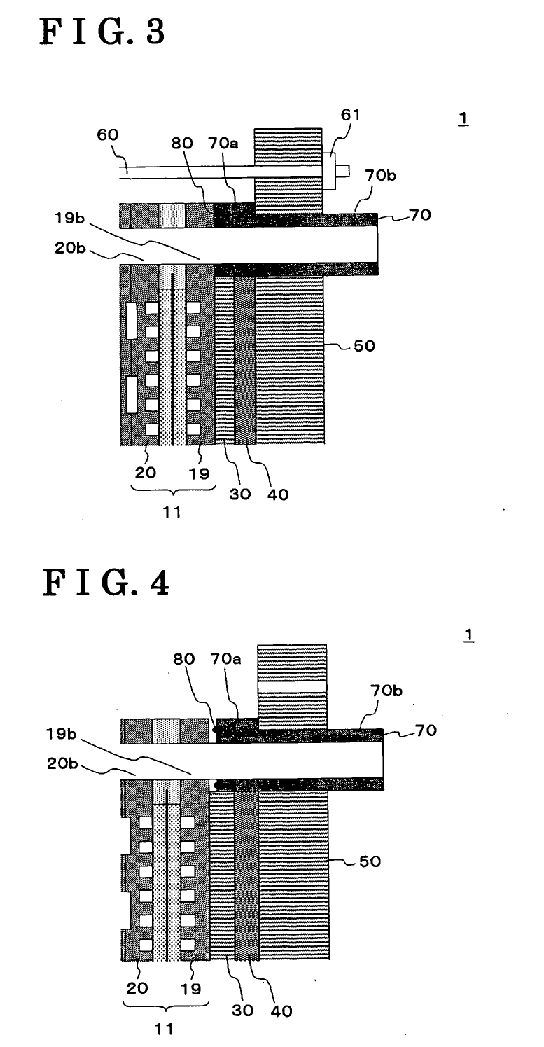

A fuel cell according to a first embodiment will be described with reference to the accompanying drawings. FIG. 1 represents a cross-sectional view of a schematic structure of the fuel cell according to the first embodiment of the present invention in a stacking direction according to the embodiment of the present invention. FIG. 2 represents a partial cross-sectional view of a detailed schematic structure of a cell stack of the fuel cell according to the first embodiment of the present invention. FIG. 3 represents a cross-sectional view of a schematic structure of an area surrounding the gas inlet/outlet of the fuel cell according to the first embodiment of the present invention. FIG. 4 represents a cross-sectional view of a schematic structure of the fuel cell in a contacting condition in which a pressure load is zero according to the first embodiment of the present invention.

The fuel cell 1 is a polymer electrolyte fuel cell. For example, the fuel cell 1 can be employed for a fuel cell vehicle. However, the fuel cell can be employed for various other purposes.

The fuel cell 1 includes a cell stack 10, a first terminal 30, a second terminal 31, a first insulator 40, a second insulator 41, a first pressure plate 50, a second pressure plate 51, and a fastening member 60 (shown in FIG. 1).

The cell stack 10 is structured from a cell 11 stacked (shown in FIG. 1). The cell 11 includes a membrane electrode assembly (MEA) having an electrolyte membrane 12 formed from an ion-exchange membrane, a first electrode 15 (anode, fuel side electrode) having a catalyst layer 13 provided on one side of the electrolyte membrane 12 and a diffusion layer 14 provided on the catalyst layer 13, and a second electrode 18 (cathode, air side electrode) having a catalyst layer 16 provided on the other side of the electrolyte membrane 12 and a diffusion layer 17 provided on the catalyst layer 16. The cell 11 further includes a first separator 19 having a first flow channel 19a for supplying and ejecting fuel gas (hydrogen) to the electrode 15 provided at both sides of the MEA, and a second separator 20 having a second flow channel 20a for supplying and ejecting oxidant gas (oxygen, normally air) to the cathode (shown in FIG. 2). The first terminal 30, and the first insulator 40 are provided at a first end of the cell stack 10 in a stacking direction. The second terminal 31 and the second insulator 41 are provided at a second end of the cell stack 10 in a stacking direction (shown in FIG. 1).

The first separator 19 includes a first flow path 19b (manifold portion) connected from the first flow channel 19a to an inlet/outlet hole (pipe member 70) of the first pressure plate 50 (shown in FIG. 3). The second separator 20 includes a second flow path 20b (manifold portion) connected from the second flow channel 20a to an inlet/outlet hole (pipe member 70) of the first pressure plate 50 (shown in FIG. 3). The first separator 19 and the second separator 20 which faces the first separator across the electrolyte membrane 12 are adhered together by an adhesive 21 applied to a gap near the peripheral portion of the flow path 20 (shown in FIG. 2). Here, the first separator 19 is in direct contact with the second separator 20 of a neighbor cell 11. However, the separators 19, 20 can be made up as a single member. Each of the first separator 19 and the second separator 20 includes a cooling water path for the flow of cooling water to cool the MEA.

Both the first terminal 30 and the second terminal 31 are electricity collecting members for extracting electricity generated at the cell stack 10 (shown in FIG. 1). The first terminal 30 is either a piece of metal or a terminal that is electrically connected directly to one end of the cell stack 10 in a stacking direction. The first terminal 30 includes an accommodating portion (opening portion or depressed portion, not shown) for accommodating a flange portion 70a of the pipe member 70. The second terminal 31 is either a piece of metal or a terminal that is electrically connected directly to the second end of the cell stack 10 also in a stacking direction. For the purpose of reducing contact resistance between the contacting surfaces, it is preferable that each of the first terminal 30 and the second terminal 31 have numerous projecting portions on the surface facing the cell stack 10. For forming the numerous projecting portions, a conductive foaming material, a conductive mesh, a conductive plate having plural projecting portions, a conductive sheet material, or a conductive plate with a surface mechanically made rough, either by use of a blast, or the like, or by use of various etching methods, or the like, can be utilized. Further, for forming the numerous projecting portions, a conductive paste or a conductive powder can be also utilized.

The first insulator 40 is an insulator for electrically insulating between the first terminal 30 and the first pressure plate 50. The first insulator 40 includes an accommodating portion (opening portion or depressed portion, not shown) for accommodating the flange portion 70a of the pipe member 70 (shown in FIG. 1). The second insulator 41 is an insulator for electrically insulating between the second terminal 31 and the second pressure plate 51. In a case where the pressure plates 50 and 51 are made of insulation material, there is no need for insulators 40 and 41 in addition. Taking the first pressure plate 50 as an example, the first pressure plate 50 is made up of insulation material, such as resin. The shape of the first pressure plate can be some cases be formed from a combination of the first pressure plate 50 shown in FIG. 1 and the first insulator 40 also shown in FIG. 1. Alternatively, in cases where the shape of the pressure plate 50 be identical to that of the pressure plate 50 shown in FIG. 1, the shape of the first terminal 30 can be formed from a combination of the first terminal 30 shown in FIG. 1 and the first insulator 40 also shown in FIG. 1.

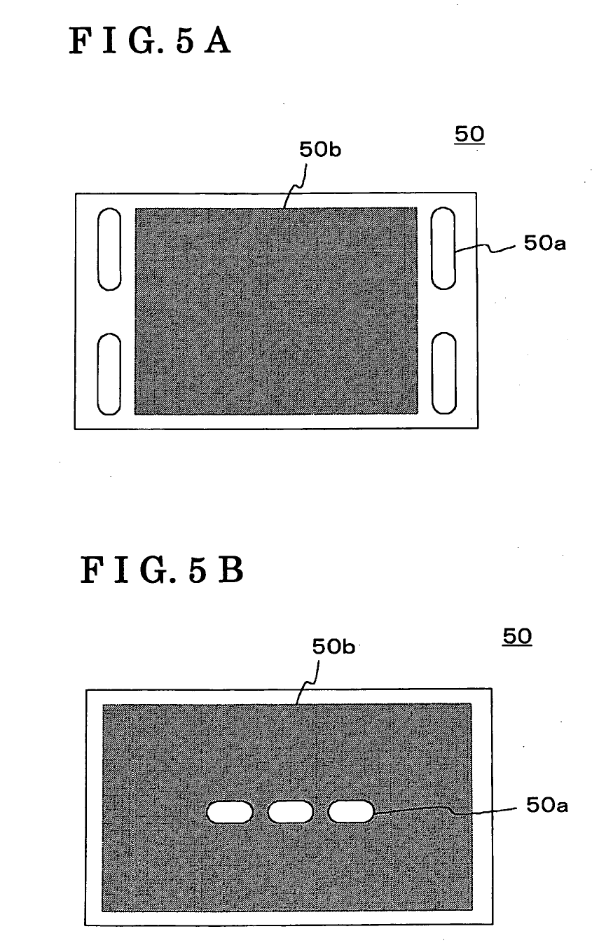

The first pressure plate 50 and the second pressure plate 51 are plates for pressing and sandwiching the cell stack 10 from the both sides of the cell stack 10. For the purpose of making the first and second pressure plates 50, 51 as light as possible, they are made of aluminum. The first and second pressure plates 50, 51 are fastened via a fastening member 60 (shown in FIG. 1). The first pressure plate 50 includes a hole (not shown) into which a first end of a fastening member 60 is inserted, and plural inlet/outlet holes (not shown) for fluids (fuel gas, air gas, moisture). A pipe portion 70b of the pipe member 70 is inserted into the inlet/outlet hole. The inlet/outlet hole of the first pressure plate 50 can be located either at a peripheral portion (shown in FIG. 5A) of an area that is in contact with the first insulator 40 (contacting portion 50b), or, alternatively, inside the area that is in contact with the first insulator 40 (shown in FIG. 5B). The second pressure plate includes a hole (not shown) into which a second end of the fastening member 60 can be inserted.

The fastening members 60 are members for fastening between the first pressure plate 50 and the second pressure plate 51. The fastening member 60 is provided outside the cell stack 10 in a horizontal stacking direction. The fastening member 60 is inserted into the hole of the first pressure plate 50 (not shown) and the hole of the second pressure plate 51 (also not shown). Ends of the fastening member 60 are respectively fastened at the first, and at the second ends with nuts 61 (shown in FIG. 1).

The pipe member 70 is a corrosion resistant member for inhibiting contamination of the catalyst of the electrode, and of the electrolyte that might be caused by corroded substances and metal ions originating in the pressure plates 50, 51. The pipe member 70 (shown in FIG. 3) is a tubular member connected from outside the flow paths 19b, 20b of the separators 19, 20. The pipe member 70 includes a pipe portion 70b inserted into the inlet/outlet hole of the first pressure plate 50. The pipe member 70 further includes a flange portion 70a at the cell stack 10 side of the first pressure plate 50. The flange portion 70a is accommodated into the accommodating portion of the first terminal 30 and the first insulator 40, and connected to the cell stack 10 as a flow path through a sealing 80. For manufacturing the pipe member 70, a resin such as polyphenylene oxide(PPO), fluorine-contained polymers, polypropylene, polyphenylene ether(PPE), polyphenylene sulfide(PPS), and nylon, or ceramics such as almina, silicon nitride, can be utilized. It is preferable to utilize PPO for manufacturing the pipe member 70. In cases where PPO has been utilized for manufacturing the pipe member 70, the pipe member 70 becomes superior in terms of corrosion resistance to hydrogen peroxide generated by an electrode reaction at the air side electrode. Further, the pipe member 70 becomes superior in terms of insulation performance. The superior insulation performance is effective for inhibiting electricity leakage from the pipe member 70.

The sealing 80 is a member for sealing for fluids. The sealing member is provided between the flange portion 70a of the pipe member 70 and the cell stack 10 (shown in FIG. 3). The sealing 80 can be a sheet-like shape other than a molded gasket. The sealing 80 can also be a liquid or an adhesive. For the sealing 80, an ethylene-propylene rubber (EDPM), a fluorine-contained rubber, a silicone rubber, or a butyl rubber can be utilized. The size of a deformation margin for the sealing 80 is determined as a size of which a difference in height between the terminal and the manifold can be duly taken into account. The size of deformation margin for the sealing 80 is also determined so as to take fully into account possible variations in the dimensions of products.

When the pressure load between the first pressure plate 50 and the second pressure plate (indicated by 51 in FIG. 1) is zero, and in a state where members located between the first pressure plate 50 and the second pressure plate (indicated by 51 in FIG. 1) are respectively in contact with neighboring members (the first terminal 30 and the second terminal 31 are in contact with the cell stack (10 in FIG. 1), in other words, a zero contacting condition when the pressure load is 0, there is a gap of from 0 mm to 3 mm between the flange portion 70a and the first separator 19 (in the cell stack) (shown in FIG. 4).

In the first embodiment, the entire end surface of the first separator 19 (an end surface in contact with the sealing 80 or the first terminal 30) is flat. In the zero contacting condition when the pressure load is 0, the sum of a thickness of the first terminal 30 and a thickness of the first insulator 40 is greater than a thickness of the flange portion 70a by from 0 mm to 3 mm (shown in FIG. 4). With the condition described above as a starting point, a pressure load is applied by the first pressure plate 50 and the second pressure plate in a stacking direction. Then the sealing 80 deforms, and the flange portion 70a and the cell stack 10 make close contact with each other as they sandwiching the sealing 80 (shown in FIG. 3). Thus, a surface of the cell stack (the first separator 19) and a surface of the first terminal 30 can make close contact.

### Second Embodiment

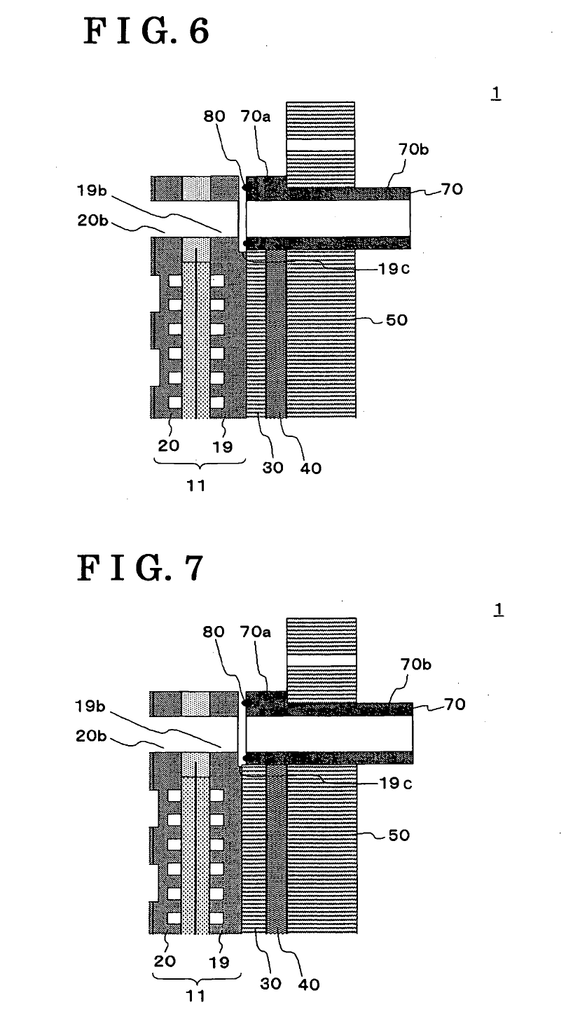

Next, a fuel cell according to a second embodiment of the present invention will be described with reference to drawing figures. FIG. 6 represents a cross-sectional view of a schematic structure of the fuel cell according to the second embodiment in a zero contacting condition, when a pressure load is zero, according to the second embodiment of the present invention. The fuel cell according to the second embodiment of the present invention is different from the fuel cell according to the first embodiment of the present invention, in terms of the structure of the cell stack 10 and the first terminal 30, or the first insulator 40.

In the second embodiment, in a zero contacting condition when the pressure load is zero, in order to form a gap of from 0 mm to 3 mm between the flange portion 70a and the first separator 19 (cell stack), a salient portion 19c is provided at the first separator 19 in an area that is in contact with the first terminal 30 (in other words, a depressed portion or a stepped portion is provided at the first separator 19 in an area in contact with the flange portion 70a via the sealing 80). In this case, if there is a gap between the flange portion 70a and the first separator 19 in a zero contacting condition when the pressure load is zero, a thickness of the flange portion 70a can be equal to or less than the sum of the thickness of the first terminal 30 and the thickness of the first insulator 40. From the condition described above, a pressure load is applied by the first pressure plate 50 and the second pressure plate (51 in FIG. 1), and the sealing 80 is deformed. Then, the flange portion 70a and the cell stack 10 make close contact with one another via the sealing 80, and a surface of the cell stack (the first separator 19) and a surface of the first terminal 30 can be put into close contact.

### Third Embodiment

Next, a third embodiment of the present invention will be described with reference to drawing figures. FIG. 7 represents a partial cross-sectional view of a schematic structure of the fuel cell in the zero contacting condition, when a pressure load is zero, according to the third embodiment of the present invention. The fuel cell according to the third embodiment of the present invention is different from the fuel cell according to the second embodiment in terms of the structure of the first terminal 30 or the first insulator 40.

In the third embodiment, in the zero contacting condition when the pressure load is zero (please refer to the first embodiment), in order to form a gap of from 0 mm to 3 mm between the flange portion 70a and the first separator 19, a salient portion 19c is provided at the first separator 19 in an area that is in contact with the first terminal 30 (in other words, a depressed portion or a stepped portion is provided at the first separator 19 in an area in contact with the flange portion 70a via the sealing 80). The sum of the thickness of the first terminal 30 and the thickness of the first insulator 40 becomes greater than that of the flange portion 70. From the condition described above, a pressure load is applied by the first pressure plate 50 and the second pressure plate (51 in FIG. 1), and the sealing 80 is deformed. Then, the flange portion 70a and the cell stack 10 make close contact with one another via the sealing 80, and a surface of the cell stack (the first separator 19) and a surface of the first terminal 30 can be put into close contact.

### Fourth Embodiment

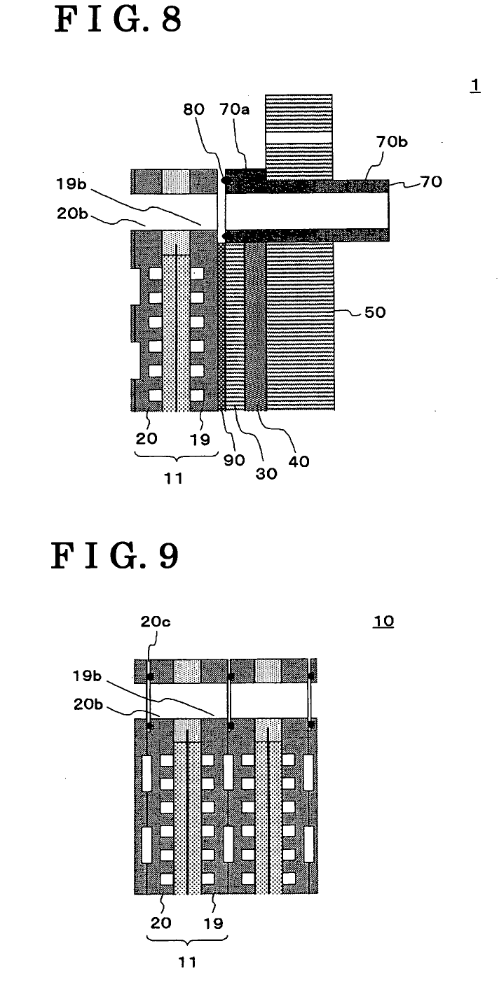

Next, a fourth embodiment of the present invention will be described with reference to drawing figures. FIG. 8 represents a partial cross-sectional view of a schematic structure of the fuel cell in the zero contacting condition when a pressure load is zero according to the fourth embodiment of the present invention. The fuel cell according to the fourth embodiment of the present invention is different from the fuel cell according to the first embodiment of the present invention in terms that a conductive member 90 be included, and the conductive member 90 be provided between the first terminal 30 and the first separator 19, instead of making the sum of the thickness of the first terminal 30 and the thickness of the first insulator 40 greater than the thickness of the flange portion 70a. For manufacturing the conductive member 90, conductive metals or alloys, (foils, sheets, surface treatment agent), carbon material (sheet-like shape, surface treatment agent), conductive resin, or the like, can be utilized. As metal or alloy, Cu, Cu alloy, Sn, Sn alloy, Zn, Zn alloy, In, In alloy, Ag, Ag alloy, Au, Au alloy, Ni, Ni alloy, or the like, can be utilized.

In the fourth embodiment, in the zero contacting condition when a pressure load is zero (please refer to the first embodiment), in order to form a gap of from 0 mm to 3 mm between the flange portion 70a and the first separator 19 (the cell stack), the conductive member 90 is provided between the cell stack 10 and the first terminal 30. From the condition described above, a pressure load is applied by the first pressure plate 50 and the second pressure plate (51 in FIG. 1), and the sealing 80 is deformed. Then, the flange portion 70a and the cell stack 10 make close contact with one another via the sealing 80, and a surface of the cell stack (the first separator 19) and a surface of the first terminal 30 can be put into close contact.

### Fifth Embodiment

Next, a fifth embodiment of the present invention will be described with reference to drawing figures. FIG. 9 represents a partial cross-sectional view of a schematic structure of the fuel cell in the zero contacting condition when a pressure load is zero according to the fifth embodiment of the present invention.

In the fifth embodiment, a gap is provided between the first separator and the flange portion in a zero contacting condition when the pressure load is zero as in from first to fourth embodiments. Further, the gap can be provided in the zero contacting condition when the pressure load is zero (in FIG. 9), between the each of first separators 19 and the each of second separators 20 of an adjacent cell, near a flange portion of the flow path 20b of the second separator 20, the flange portion is shaped as depressed portion (stepped portion). A sealing 80 is provided at the flange portion 20c. From the condition described above, a pressure load is applied by the first pressure plate 50 and the second pressure plate (51 in FIG. 1), and the sealing 80 is deformed. Then, the flange portion 20c and the first separator 19 of the adjacent cell are make close contact via the sealing 80, and a surface of the conductive portion of the first separator 19 of the adjacent cell can be put into close contact.

In this case, a gap can be formed by making a depressed portion (stepped portion) at flange portions of both the first separator 19 and the second separator 20, or at a flange portion of one of the first separator 19 and the second separator 20. Further, a gap can be formed between the first separator 19 and the second separator 20, at a flange portion 20c adjacent to, and in contact with the first separator 19 of the adjacent cell via the conductive member.

According to an aspect of the present invention, even in a case where an inlet/outlet hole is covered with a corrosion resistant member, contacting surface pressure of the terminal to the cell can be ensured. Therefore, the cell stack (electricity collecting portion thereof) and the terminal can be put into close contact with one another, and degradation of performance of the fuel cell caused by contacting failure can be prevented.

According to a further aspect of the present invention, by controlling a level of pressure applied by the pressure plate, contacting surface pressure of the terminal to the cell can be ensured, and simultaneously, a deformation margin of the sealing between the separator and a gas pipe can be ensured.

According to a further aspect of the present invention, the cell and the terminal can be put into contact with one another in the same area as in the apparent contacting area. Therefore, uneven loads of the contacting surface can be prevented, and breakages of the cell can also be prevented.

According to a further aspect of the present invention, electrical contacting between the cell and the terminal can be ensured in cases where the inlet/outlet hole of the pressure plate is provided at either a peripheral portion or an inner portion of the pressure plate in an area that is contacted with the cell stack.

According to a further aspect of the present invention, electrical contacting can be ensured between adjacent cells. Therefore, degradation of performance of the fuel cell caused by contacting failure can be prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A fuel cell, comprising:
a cell stack formed by stacking a plurality of cells, each cell having
a membrane electrode assembly having an electrolyte membrane and an electrode provided at each side of the electrolyte membrane,
a flow channel for supplying fluid to the electrode, and
separators each having a flow path from the flow channel to outside the fuel cell stack;
a pair of terminals provided so as one terminal is positioned at one end of the cell stack and the other terminal is positioned at the other end of the cell stack;
a pair of pressure plates provided for sandwiching and fastening the cell stack from outside the terminals, each pressure plate including an inlet/outlet hole connected to the flow path; and
a pipe member connected to the flow path, the pipe member being made of a corrosion resistant material, and including a pipe portion inserted into the inlet/outlet hole, and a flange portion at the cell stack side of one of the pressure plates, wherein
one of the terminals has an accommodating portion for accommodating the pipe member,
and a gap is formed between the flange portion of the pipe member and the cell stack under a zero contacting condition when a pressure load of the pair of the pressure plates is zero, in which any one of the members of the cell stack and the terminal provided between the pressure plates is in contact with the neighboring member.

2. The fuel cell according to claim 1, wherein
the gap formed between the flange portion of the pipe member and the cell stack is from 0 mm to 3 mm.

3. The fuel cell according to claim 1, wherein
a salient portion is provided in an area which is in contact with the one of the terminals.

4. The fuel cell according to claim 3, wherein
a height of the salient portion is from 0 mm to 3 mm.

5. The fuel cell according to claim 1, wherein
an insulator is provided between the one of the terminals and the one of the pressure plates for insulation therebetween, and includes an accommodating portion for accommodating the flange portion of the pipe member.

6. The fuel cell according to claim 5, wherein
a sum of a thickness of the one of the terminals and a thickness of the insulator is greater than a thickness of the flange portion of the pipe member by a difference from 0 mm to 3 mm.

7. The fuel cell according to claim 1, wherein
a conductive member is provided between the cell stack and either one of the terminals.

8. The fuel cell according to claim 7, wherein
a thickness of the conductive member is from 0 mm to 3 mm.

9. The fuel cell according to claim 7, wherein
a material for the conductive member is selected from a metal, a carbon material, and a conductive resin.

10. The fuel cell according to claim 1, wherein
a plurality of projections are provided at a surface of at least one of the terminals, the surface in contact with the cell stack.

11. The fuel cell according to claim 1, wherein
a sealing member is provided between the flange portion of the pipe member and the cell stack.

12. The fuel cell according to claim 11, wherein
a material for the sealing member is selected from an ethylene-propylene rubber, a fluorine-contained rubber, a silicone rubber, and a butyl rubber.

13. The fuel cell according to claim 1, wherein
a material for the pipe member is selected from a polyphenylene oxide, a fluorine-contained polymer, a polypropylene, a polyphenylene ether, a polyphenylene sulfide, a nylon, and a ceramic.

14. The fuel cell according to claim 1, wherein
a polyphenylene oxide is used as a material for the pipe member.

15. The fuel cell according to claim 1, wherein
the separators facing each other across the electrolyte membrane are bonded to each other by use of adhesive at a gap provided near a peripheral portion of the flow path.

16. A fuel cell, comprising:
a cell stack formed by stacking a plurality of cells, each stacked cell having
a membrane electrode assembly having an electrolyte membrane and an electrode provided at each side of the electrolyte membrane,
a flow channel for supplying fluid to the electrode, and
separators each having a flow path from the flow channel to outside the cell stack, wherein
when a pressure load applied to the cell stack in a stacking direction is zero, and when cells adjacent each other is in contact with each other at a time of a zero contacting condition, a gap is provided between flange portions of the separators of the adjacent cells.

17. The fuel cell according to claim 16, wherein
the gap is from 0 mm to 3 mm.

18. The fuel cell according to claim 16, wherein
the gap is formed by making a stepped portion at a flange portion of one of the separators.

19. The fuel cell according to claim 16, wherein
the gap is formed by providing a conductive member between the separators facing each other.

20. The fuel cell according to claim 19, wherein
a thickness of the conductive member is from 0 mm to 3 mm.
